(19) United States
(12) Patent Application Publication
(10) Pub. No.: US 2026/0138597 A1
(43) Pub. Date: May 21, 2026

(54) CONTROL DEVICE, CONTROL METHOD, AND STORAGE MEDIUM

(71) Applicant: HONDA MOTOR CO., LTD., Tokyo (JP)

(72) Inventors: Hideto SHIOTANI, Tokyo (JP); Daisuke ISHIZUKA, Tokyo (JP); Kuniyoshi TANAKA, Tokyo (JP); Shoichi KOBAYASHI, Tokyo (JP); Kenichi OHSHIMA, Tokyo (JP); Hideo NAKAHAMA, Tokyo (JP); Tomo FUJIMAKI, Tokyo (JP); Kazuki YAMANO, Tokyo (JP); Hideki NAGATOMO, Tokyo (JP); Yuki HARA, Tokyo (JP); Yuhei SHINGAI, Tokyo (JP)

(73) Assignee: HONDA MOTOR CO., LTD., Tokyo (JP)

(21) Appl. No.: 19/390,150

(22) Filed: Nov. 14, 2025

(30) Foreign Application Priority Data
Nov. 15, 2024 (JP) 2024-199472

(51) Int. Cl. B60W 30/06

(52) U.S. Cl. CPC B60W 30/06; B60W 2552/05; B60W 2556/25; B60W 2556/40; B60W 2556/50

(57) ABSTRACT

A control device for a moving object, the control device includes: a storage that stores parking information indicating a movement start point, a parking section, and a movement route of the moving object from the movement start point to the parking section; and processing circuitry configured to perform position estimation processing with estimation accuracy, the position estimation processing including acquiring external environment information of the moving object, extracting a feature from the external environment information, and estimating a position of the moving object based on the feature and map information, and perform movement control to move the moving object from the movement start point to the parking section based on a result of the position estimation processing and the parking information, in which the processing circuitry is configured to set the estimation accuracy based on a distance between the movement start point and the moving object.

This application is based upon and claims the benefit of priority from prior Japanese patent application No. 2024-199472, filed on Nov. 15, 2024, the entire contents of which are incorporated herein by reference.

### TECHNICAL FIELD

The present disclosure relates to a control device, a control method, and a storage medium storing a control program.

### BACKGROUND ART

In recent years, active efforts have been made to provide access to a sustainable transportation system in consideration of vulnerable people among traffic participants. In order to implement the above, research and development on further improving safety and convenience of traffic by research and development related to driving assistance technology have been focused on.

In an autonomous driving system that causes a vehicle to travel autonomously without requiring a driving operation of a user, it has been known that a route taken when a vehicle travels to a target position by a driving operation of a user is stored, and when the vehicle travels toward the same target position or on the same route, the vehicle is subjected to movement control based on a stored route history. It is also known that route information on a route from a current position to the target position is generated based on information acquired by an in-vehicle sensor to perform the movement control on the vehicle.

For example, JP2024-024924A describes a parking assistance device that is configured to execute parking assistance control using a registered parking position as a target parking position when a current position of a vehicle acquired by a position acquisition device is a point near a registered parking position stored in a memory.

### SUMMARY OF INVENTION

Incidentally, when performing movement control on a vehicle to a target position, a technique is used that estimates a traveling position of the vehicle by comparing stored peripheral environment features with peripheral environment features obtained during current traveling, and then performs the movement control. In order for a vehicle in traveling to travel accurately along a stored route to the target position, it is necessary to constantly extract peripheral environment features in traveling and compare the extracted features with the stored features. However, the processing of acquiring peripheral environment information, extracting features from the acquired peripheral environment information, and comparing the extracted features leads to a high processing load, resulting in a problem of increased power consumption. JP2024-024924A does not describe reducing the power consumption by reducing the processing load for estimating a traveling position of a vehicle in movement control for causing the vehicle to travel along a route to a target position.

Aspects of the present disclosure relates to providing a control device, a control method, and a storage medium storing a control program that can reduce power consumption associated with position estimation processing while preventing a decrease in convenience.

According to an aspect of the present disclosure, there is provided a control device for a moving object, the control device including:
a storage that stores parking information indicating a movement start point of the moving object, a parking section for the moving object, and a movement route of the moving object from the movement start point to the parking section; and
processing circuitry configured to
   perform position estimation processing with estimation accuracy, the position estimation processing including acquiring external environment information of the moving object, extracting a feature from the external environment information, and estimating a position of the moving object based on the feature and map information, and
   perform movement control to move the moving object from the movement start point to the parking section based on a result of the position estimation processing and the parking information, in which
the processing circuitry is configured to set the estimation accuracy based on a distance between the movement start point and the moving object.

According to another aspect of the present disclosure, there is provided a control method of a control device for a moving object, the control method including:
storing parking information indicating a movement start point of the moving object, a parking section for the moving object, and a movement route of the moving object from the movement start point to the parking section;
performing position estimation processing with estimation accuracy, the position estimation processing including acquiring external environment information of the moving object, extracting a feature from the external environment information, and estimating a position of the moving object based on the feature and map information;
performing movement control to move the moving object from the movement start point to the parking section based on a result of the position estimation processing and the parking information; and
setting the estimation accuracy based on a distance between the movement start point and the moving object.

According to another aspect of the present disclosure, there is provided a non-transitory computer-readable storage medium storing a control program that causes a processor of a control device for a moving object to execute a process, the process including
storing parking information indicating a movement start point of the moving object, a parking section for the moving object, and a movement route of the moving object from the movement start point to the parking section,
performing position estimation processing with estimation accuracy, the position estimation processing including acquiring external environment information of the moving object, extracting a feature from the external environment information, and estimating a position of the moving object based on the feature and map information,
performing movement control to move the moving object from the movement start point to the parking section based on a result of the position estimation processing and the parking information, and
setting the estimation accuracy based on a distance between the movement start point and the moving object.

According to the aspects of the present disclosure, it is possible to provide a control device, a control method, and a storage medium storing a control program that can reduce power consumption associated with position estimation processing while preventing a decrease in convenience.

### BRIEF DESCRIPTION OF DRAWINGS

Exemplary embodiment(s) of the present invention will be described in detail based on the following figures, wherein:

FIG. 1 is a side view of an example of a vehicle 10 equipped with a control device of the present disclosure;

FIG. 2 is a top view of the vehicle 10 illustrated in FIG. 1;

FIG. 3 is a block diagram illustrating an example of an internal configuration of the vehicle 10 illustrated in FIG. 1;

FIG. 4 is a diagram illustrating a first example of controlling estimation accuracy of position estimation processing;

FIG. 5 is a flowchart illustrating a first example of the position estimation processing;

FIG. 6 is a diagram illustrating a first example of a change in estimation accuracy in the position estimation processing;

FIG. 7 is a diagram illustrating a second example of controlling the estimation accuracy of the position estimation processing;

FIG. 8 is a flowchart illustrating a second example of the position estimation processing;

FIG. 9 is a diagram illustrating a second example of the change in the estimation accuracy in the position estimation processing; and

FIG. 10 is a flowchart illustrating a third example of the position estimation processing.

### DESCRIPTION OF EMBODIMENTS

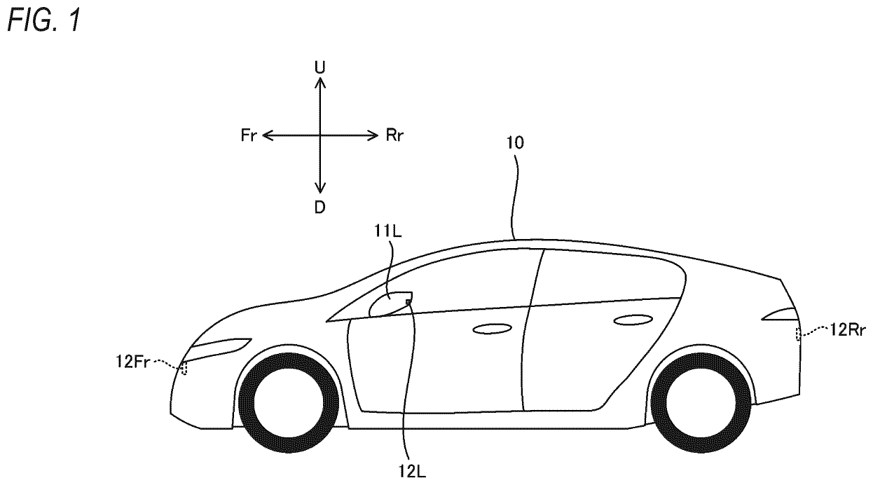

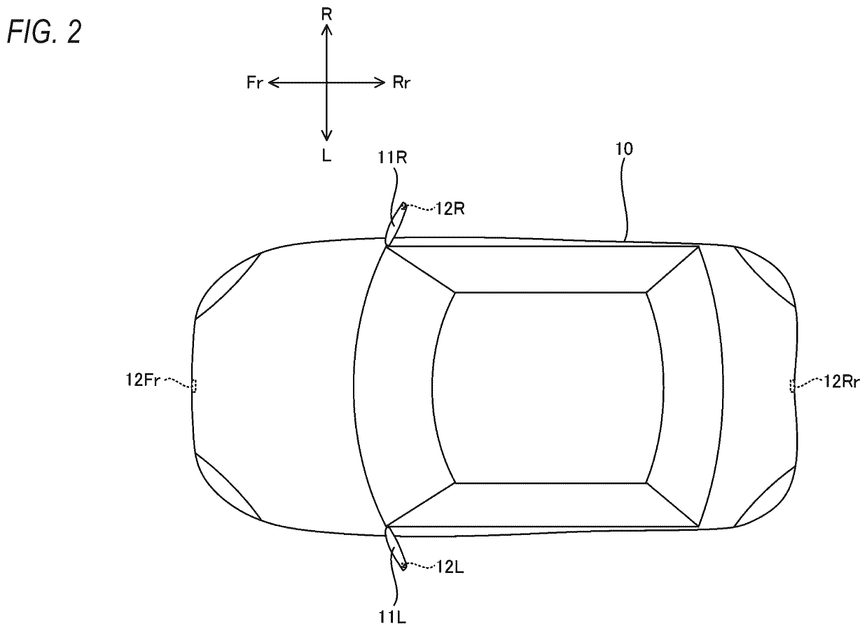

Hereinafter, an embodiment of a control device, a control method, and a storage medium storing a control program of the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 illustrated in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Equipped with Control Device

FIG. 1 is a side view of an example of the vehicle 10 equipped with a control device in the present disclosure. FIG. 2 is a top view of the vehicle 10 illustrated in FIG. 1. The vehicle 10 is an example of the “moving body” in the present disclosure.

The vehicle 10 is an automobile including a drive source (not illustrated) and wheels including drive wheels driven by power of the drive source and steerable steered wheels. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by pivoting about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

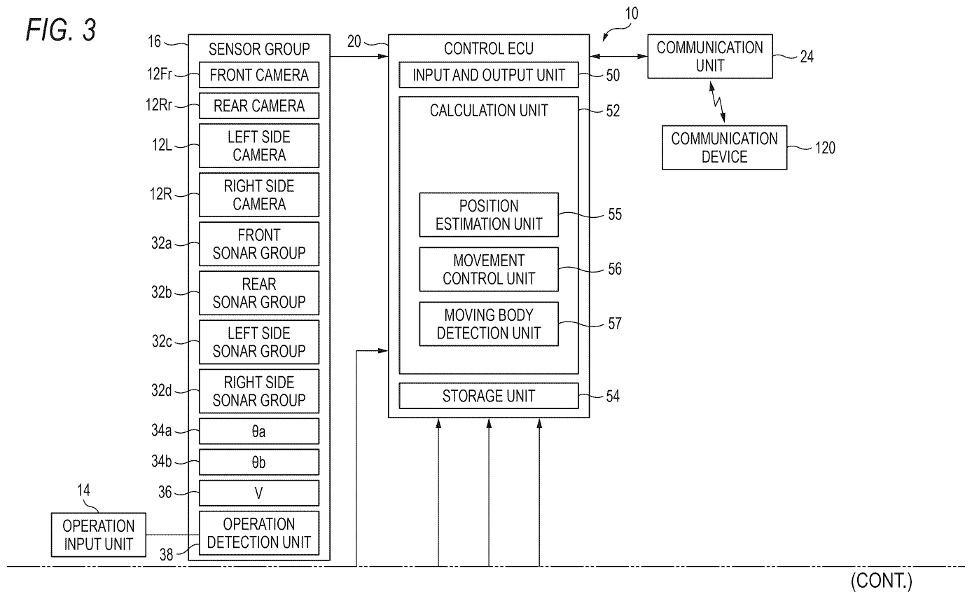

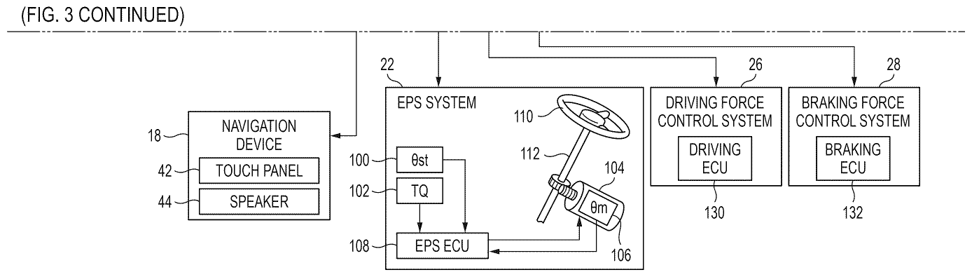

FIG. 3 is a block diagram illustrating an example of an internal configuration of the vehicle 10 illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire external environment recognition data (for example, external environment images) for recognizing surroundings of the vehicle 10 by capturing images of an external environment of the vehicle 10. The external environment images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the external environment of the vehicle, which is generated by combining the images captured by the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches the side mirrors 11L and 11R between opened and closed states, and a shift lever (a selector lever or a selector).

The navigation device 18 detects a current position (position coordinates) of the vehicle 10 by using, for example, a global positioning system (GPS), and guides the user along a movement route to a destination. The navigation device 18 includes a storage device (not illustrated) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a memory parking button for requesting parking by automatic steering of the control ECU 20, and a parking support button for requesting support while parking the vehicle by an operation of the user. The exiting assistance button includes a memory exiting button for requesting exiting by the automatic steering of the control ECU 20, and an exiting support button for requesting support while exiting by an operation of the user. Note that a constituent element other than the touch panel 42, for example, an information terminal such as a smartphone or a tablet may be used as the input device or the display device.

Note that the “parking” is synonymous with, for example, “parking”. For example, the “parking” is a stop as the user gets on and off the vehicle, and excludes a temporary stop due to a traffic signal or the like. Further, the “parking section” means a section where the vehicle 10 is to be stopped, that is, a section to be parked.

The control ECU 20 includes an input and output unit 50, a calculation unit 52, and a storage unit 54. The calculation unit 52 is implemented by, for example, processing circuitry such as a processor or a central processing unit (CPU). The calculation unit 52 executes various types of control by controlling units based on a program stored in the storage unit 54. The calculation unit 52 receives and outputs signals from and to each unit connected to the control ECU 20 via the input and output unit 50. The control ECU 20 is an example of a “control device” in the present disclosure.

The storage unit 54 stores information on memory movement (memory parking or exiting) of the vehicle 10. The information on the memory movement is information for autonomous movement or assisted movement of the vehicle 10 based on pre-stored movement information. For example, the storage unit 54 stores parking information indicating a movement start point from which the memory movement starts, a parking section where the vehicle 10 is stopped by the memory movement, and a movement route from the movement start point to the parking section.

The calculation unit 52 includes a position estimation unit 55 that performs position estimation processing of the vehicle 10, a movement control unit 56 that performs movement control on the vehicle 10, and a moving body detection unit 57 that detects a moving body around the vehicle 10.

The position estimation unit 55 performs the position estimation processing that includes acquiring external environment information of the vehicle 10, extracting features from the external environment information, and estimating a position of the vehicle 10 based on the features and map information. “Acquiring external environment information” means acquiring external environment information of the vehicle 10 captured by the front camera 12Fr, rear camera 12Rr, left side camera 12L, and right side camera 12R. The “features from the external environment information” are characteristic objects, for example, included in the external environment information on a movement route of the vehicle 10.

The movement control unit 56 performs memory parking assistance and memory exiting assistance of the vehicle 10 through automatic steering in which a steering 110 is automatically operated under control of the movement control unit 56. In the memory parking assistance and the memory exiting assistance, an accelerator pedal (not illustrated), a brake pedal (not illustrated), and the operation input unit 14 are automatically operated. The movement control unit 56 performs support parking assistance and support exiting assistance when the user (driver) operates the accelerator pedal, the brake pedal, and the operation input unit 14 to perform manual parking and manual exiting of the vehicle 10. Note that during the memory parking assistance and the memory exiting assistance, the driver may be in a state of being present in the vehicle 10, or may be in a state of getting off the vehicle 10 and being outside (not being present in the vehicle).

For example, the movement control unit 56 performs movement control to move the vehicle 10 based on a result of the position estimation processing by the position estimation unit 55 and parking information stored in the storage unit 54 indicating a movement start point, a parking section, and a movement route. The movement control is, for example, parking control that causes the vehicle 10 to perform memory parking in a predetermined parking section (target parking position) from a movement start point. The movement control unit 56 can execute the parking control and exiting control based on an instruction signal input via the input and output unit 50. The input instruction signal includes an instruction signal transmitted by wireless communication from an information terminal or the like of the user. The movement control unit 56 outputs information on the parking control and the exiting control to the information terminal or the like via the input and output unit 50.

The moving body detection unit 57 detects a moving body present around the vehicle 10 based on the external environment information of the vehicle 10. The “moving body” includes, for example, pedestrians, bicycles, and other vehicles.

The position estimation unit 55 controls estimation accuracy of the position estimation processing based on a distance between the movement start point and the vehicle 10. The “distance” is detected based on, for example, GPS information. The position estimation unit 55 performs control such that the shorter the distance between the movement start point and the vehicle 10, the higher the estimation accuracy of the position estimation processing. For example, the position estimation unit 55 is capable of performing position estimation processing by first position estimation processing and second position estimation processing which has higher estimation accuracy and a higher processing load than the first position estimation processing, and performs the first position estimation processing when the “distance” is equal to or greater than a predetermined value, and performs the second position estimation processing when the “distance” is less than the predetermined value. The estimation accuracy of the position estimation processing may be switched between three or more levels, or may be changed continuously according to the distance.

“Controlling the estimation accuracy of the position estimation processing” means changing at least one from imaging processing of imaging the external environment information to matching processing of comparing the features in the external environment information. For example, “controlling the estimation accuracy of the position estimation processing” includes increasing the estimation accuracy by increasing an image quality of the cameras, and decreasing the estimation accuracy by decreasing the image quality. “Controlling the estimation accuracy of the position estimation processing” also includes increasing the estimation accuracy by narrowing a range of camera images to be compared, and decreasing the estimation accuracy by widening the range. “Controlling the estimation accuracy of the position estimation processing” also includes changing the estimation accuracy by suspending the matching processing at a certain time. “Controlling the estimation accuracy of the position estimation processing” also includes pre-setting a high-priority parking lot and a low-priority parking lot, and prioritizing the position estimation processing for the high-priority parking lot to reduce the number of matching targets. Generally, the higher the estimation accuracy, the larger the processing load on the position estimation unit 55 and the higher the power consumption.

In a case where a predetermined condition related to the movement start point is satisfied, the position estimation unit 55 increases the estimation accuracy of the position estimation processing during a period when the vehicle 10 is traveling in a section immediately before the movement start point as compared with a case where the predetermined condition is not satisfied. The “section immediately before the movement start point” is, for example, a section a predetermined distance before the movement start point (for example, 10 m before the movement start point). “Increases the estimation accuracy” means, for example, when the estimation accuracy of the position estimation processing can be switched between a plurality of levels, setting to the estimation accuracy at the highest level. The estimation accuracy does not have to be increased for the entire “section immediately before the movement start point” but may be increased for at least a part thereof.

The predetermined condition includes, for example, that the movement start point is set to be near a boundary between an ordinary road and a non-ordinary road. The “non-ordinary road” may be, for example, a private road or an area that is not set as a road. “Near the boundary” means, for example, that a distance from the boundary is equal to or less than a threshold. The predetermined condition also includes that the movement start point is set to be near a boundary and that the vehicle 10 is traveling on an ordinary road. “Traveling on an ordinary road” does not mean, for example, a situation in which a vehicle is about to leave a private road and enter an ordinary road, but rather a situation in which the vehicle is about to leave an ordinary road and enter a private road.

When the predetermined condition is satisfied, the position estimation unit 55 sets the estimation accuracy in the section immediately before the movement start point to a predetermined accuracy, and makes the estimation accuracy variable when the vehicle 10 enters a non-ordinary road. The “predetermined accuracy” refers to a fixed value of the estimation accuracy, and for example, when the estimation accuracy can be switched between a plurality of levels, the “predetermined accuracy” refers to the estimation accuracy at the highest level. “Makes the estimation accuracy variable” means controlling the estimation accuracy according to, for example, the peripheral environment or the traveling state of the vehicle 10, and making the estimation accuracy lower than predetermined accuracy.

The position estimation unit 55 controls the estimation accuracy of the position estimation processing based on the number of the moving body present around the vehicle 10 detected by the moving body detection unit 57. For example, in a case where the number of the moving body present around the vehicle 10 is a first predetermined number or more, the position estimation unit 55 performs control to increase the estimation accuracy of the position estimation processing as compared with a case where the number of the moving body is less than the first predetermined number. In a case where the number of the moving body present around the vehicle 10 is equal to or greater than a second predetermined number that is greater than the first predetermined number, the position estimation unit 55 performs control to decrease the estimation accuracy of the position estimation processing as compared with a case where the number of the moving body is equal to or greater than the first predetermined number and less than the second predetermined number. “Decrease” means, for example, making the estimation accuracy equivalent (for example, the same) as in the case where the number of the moving body is less than the first predetermined number. Note that when the number of the moving body is equal to or greater than the second predetermined number, the estimation accuracy may be lower than when the number is less than the first predetermined number. Specifically, when there are too many pedestrians or the like around the vehicle 10 (the case of the second predetermined number or more), the estimation accuracy is decreased since a load of the matching processing for the features and the like increases.

An EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for the user's operation on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 enables wireless communication with another communication device 120. Another communication device 120 includes a base station, a communication device of another vehicle, an information terminal such as a smartphone or a tablet carried by the user of the vehicle 10, and the like. For example, the communication unit 24 includes an ultra wide band (UWB, registered trademark) interface or the like that can execute UWB communication with the information terminal. The communication unit 24 can transmit and receive information on memory parking and exiting and assisted parking and exiting of the vehicle 10 to and from an information terminal or the like.

The driving force control system 26 includes a driving ECU 130. The driving force control system 26 executes driving force control of the vehicle 10. The driving ECU 130 controls a driving force of the vehicle 10 by controlling an engine or the like (not illustrated) based on an operation performed by the user on the accelerator pedal (not illustrated).

The braking force control system 28 includes a braking ECU 132. The braking force control system 28 executes braking force control of the vehicle 10. The braking ECU 132 controls a braking force of the vehicle 10 by controlling a braking mechanism or the like (not illustrated) based on an operation performed by the user on the brake pedal (not illustrated).

### First Example of Controlling Estimation Accuracy

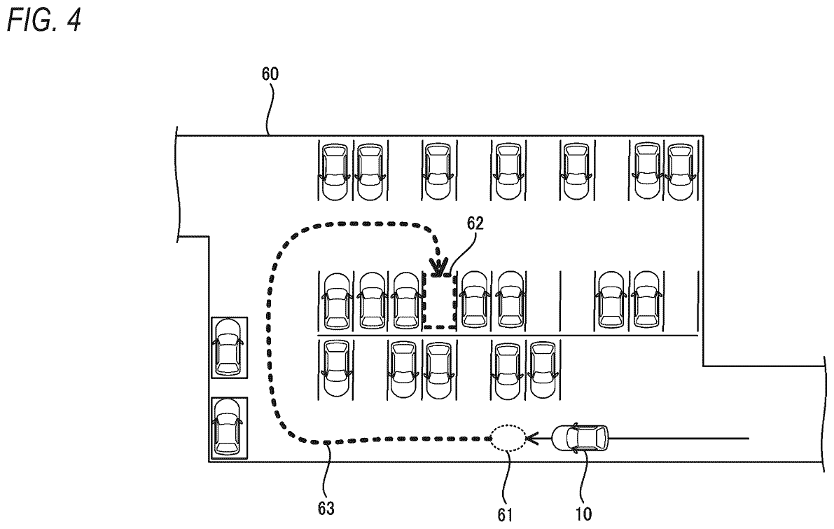

FIG. 4 is a diagram illustrating a first example of controlling the estimation accuracy of the position estimation processing. As illustrated in FIG. 4, the vehicle 10 performs control to change the estimation accuracy of the position estimation processing when the vehicle 10 is parked in a parking facility 60 using the memory parking, for example.

The parking facility 60 is, for example, a parking facility at a shopping mall that is frequently used by the user of the vehicle 10. The user of the vehicle 10 frequently uses a parking section 62 among the plurality of parking sections in the parking facility 60 as a place to park the vehicle 10, and registers the parking section 62 in the storage unit 54 as a parking section in which the memory parking can be performed. As illustrated in FIG. 4, the parking section 62 is registered in the storage unit 54 as parking information for performing the memory parking, along with a movement start point 61 from which the vehicle 10 begins to move when performing the memory parking, and a movement route 63 (dashed arrow) along which the vehicle 10 travels from the movement start point 61 to the parking section 62.

To register the parking information, first, the user manually drives the vehicle 10 to travel and stops the vehicle 10 at any movement start point (for example, the movement start point 61). Next, the user presses, for example, a “start parking information registration” button (not illustrated) for starting the registration of the parking information, and then starts the registration. The user manually drives the vehicle 10 to travel along any route (for example, the movement route 63) and parks the vehicle 10 in any parking section (for example, the parking section 62). Next, the user presses, for example, an “end parking information registration” button (not illustrated) for ending the registration of the parking information, and then ends the registration. Note that the movement route 63 shown in the present embodiment is displayed in a simplified manner, but may include a route that requires a quick turn, for example, when backing the vehicle 10 into the parking section 62. The parking information may also include features in the external environment information acquired while the vehicle 10 is traveling along the movement route 63.

### First Example of Position Estimation Processing

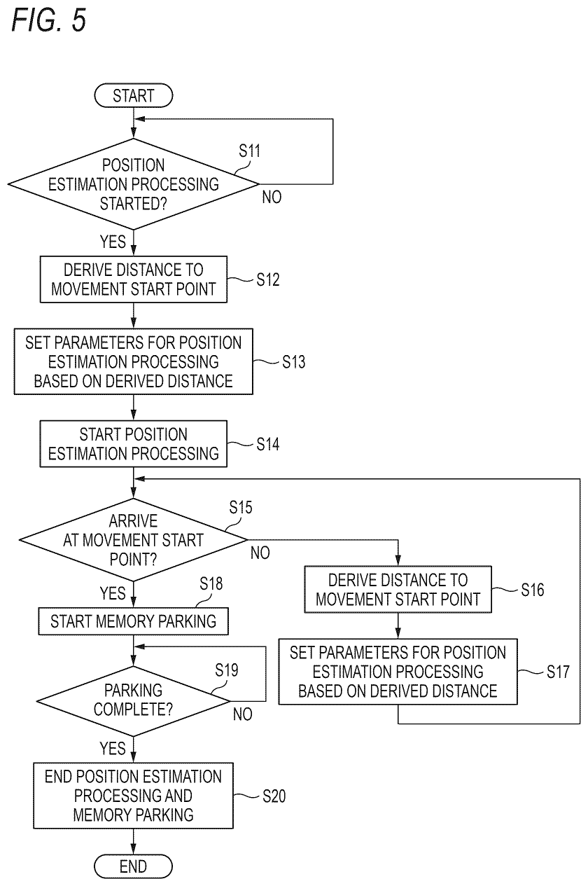

FIG. 5 is a flowchart illustrating a first example of the position estimation processing. The present example will be described below as position estimation processing when the vehicle 10 performs memory parking in the parking facility 60 illustrated in FIG. 4. This position estimation processing is executed repeatedly while the vehicle 10 is traveling.

First, the vehicle 10 determines whether to start the position estimation processing (step S11). The position estimation processing is started when it is detected that the vehicle 10 has entered the parking facility 60 such as that illustrated in FIG. 4 in which parking information related to memory parking is stored. The position estimation processing may also be started by, for example, a distance between the movement start point 61 of the parking facility 60 and the vehicle 10 becoming equal to or less than a predetermined distance (for example, 100 m). The position estimation processing may also be started when the user presses, for example, a “parking assistance button” to activate a memory parking function. Note that it is assumed that the vehicle 10 is being manually driven to travel by the user.

If it is determined in step S11 that the position estimation processing is not to be started (step S11: No), the vehicle 10 repeats the processing of step S11. If it is determined in step S11 that the position estimation processing is to be started (step S11: Yes), the vehicle 10 derives a distance from a current position of the vehicle 10 to the movement start point 61 based on, for example, GPS information (step S12).

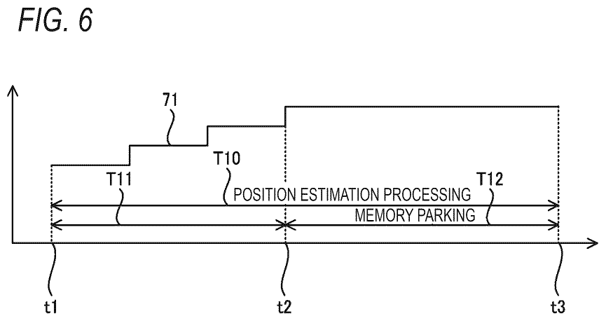

The vehicle 10 sets parameters for the position estimation processing of the vehicle 10 based on the distance derived in step S12 (step S13). The parameters are parameters that determine the estimation accuracy of the position estimation processing, and include, for example, the image quality of the cameras, the range of the camera images, the time and the target of the matching processing, an algorithm, and the like. The parameters are set according to the distance to the movement start point 61, for example, so that the estimation accuracy changes as will be described later with reference to FIG. 6. Note that increasing the estimation accuracy increases the processing load on the position estimation unit 55, whereas decreasing the estimation accuracy reduces the processing load on the position estimation unit 55.

The vehicle 10 starts the position estimation processing of the vehicle 10 based on the features extracted from the external environment information and the map information using the parameters set in step S13 (step S14).

Next, the vehicle 10 determines whether a traveling position has arrived at the movement start point 61 (step S15). For example, the vehicle 10 uses GPS information from the navigation device 18 to determine whether the traveling position has arrived at the movement start point 61. Alternatively, the vehicle 10 may determine that the vehicle 10 has arrived at the movement start point 61 when the user stops the vehicle 10 and presses the “parking assistance button” for starting the memory parking.

If it is determined in step S15 that the vehicle 10 has not arrived at the movement start point 61 (step S15: No), the vehicle 10 derives the distance from the current position of the vehicle 10 to the movement start point 61 based on, for example, GPS information (step S16). The vehicle 10 sets parameters for the position estimation processing based on the distance derived in step S16 (step S17). The vehicle 10 returns to step S15 and performs the position estimation processing using the parameters set in step S17.

On the other hand, if it is determined in step S15 that the vehicle 10 has arrived at the movement start point 61 (step S15: Yes), the vehicle 10 starts the memory parking that moves the vehicle 10 from the movement start point 61 to the parking section 62 based on the result of the position estimation processing and the parking information stored in the storage unit 54 (step S18).

Next, the vehicle 10 determines whether the parking of the vehicle 10 in the parking section 62 by the memory parking has been completed (step S19).

If it is determined in step S19 that the parking is not completed (step S19: No), the vehicle 10 repeats the processing of step S19. If it is determined in step S19 that the parking is completed (step S19: Yes), the vehicle 10 ends the position estimation processing and the memory parking (step S20).

Note that while the memory parking is being performed in steps S18 and S19, the estimation accuracy may be controlled (for example, decreased) depending on the peripheral environment and the traveling state of the vehicle 10, or may be set as fixed estimation accuracy (for example, the highest). In the above description, the vehicle 10 is described as being manually driven to travel by the user from the time when the vehicle 10 enters the parking facility 60 until the vehicle 10 arrives at the movement start point 61, but the present invention is not limited thereto. The traveling of the vehicle 10 may be autonomous traveling in which the vehicle 10 is controlled to move to movement start point 61 based on the result of the position estimation processing and the movement start point 61, for example.

### First Example of Change in Estimation Accuracy

FIG. 6 is a diagram illustrating a first example of a change in the estimation accuracy in the position estimation processing. The change in the estimation accuracy in the present example is applied when memory parking is performed in the parking facility 60 illustrated in FIG. 4, for example. In FIG. 6, a time t1 on a horizontal axis indicates a timing at which the position estimation processing starts. A time t2 is a timing at which the vehicle 10 arrives at the movement start point 61 of the parking facility 60, and indicates a timing at which the memory parking begins. A time t3 indicates a timing at which the memory parking of the vehicle 10 is completed. A vertical axis indicates a level of the estimation accuracy.

A period T10 from the time t1 to the time t3 is a period during which the position estimation processing for the vehicle 10 is performed. A period T11 from the time t1 to the time t2 is a period of manual driving by the user from when the vehicle 10 enters the parking facility 60 until when the vehicle 10 arrives at the movement start point 61. A period T12 from the time t2 to the time t3 is a period during which the vehicle 10 is caused to travel by the memory parking from the movement start point 61 to the parking section 62 based on the result of the position estimation processing and the parking information.

The time t1 at which the position estimation processing starts is a timing at which it is detected that the vehicle 10 has entered the parking facility 60. When the vehicle 10 enters the parking facility 60, the vehicle 10 starts the position estimation processing, and estimation accuracy 71 of the position estimation processing is gradually increased according to the distance between the vehicle 10 and the movement start point 61. In the present example, after the start of the position estimation processing (time t1), the vehicle 10 increases the estimation accuracy by four levels as the distance from the vehicle 10 to the movement start point 61 becomes shorter. Note that in the present example, the estimation accuracy after arrival at the movement start point 61 (time t2) is maintained at the highest level, but the estimation accuracy may be decreased as appropriate. For example, the estimation accuracy may be increased as the vehicle 10 approaches the movement start point 61, may reach the highest level just before arriving at the movement start point 61, and then the level of the estimation accuracy after arriving at the movement start point 61 may be decreased. By decreasing the estimation accuracy, it is possible to reduce the processing load on the position estimation unit 55.

As described above, the control device of the present embodiment controls the estimation accuracy of the position estimation processing based on the distance between the movement start point 61 and the vehicle 10, and increases the estimation accuracy as the distance becomes shorter. With this configuration, it is possible to accurately estimate the position of the vehicle 10 near the movement start point 61. Therefore, a situation can be prevented in which memory parking cannot be started along the movement route 63 from the movement start point 61 to the parking section 62, and the vehicle 10 is allowed to start traveling smoothly along the movement route 63. Since the estimation accuracy of the position estimation processing can be controlled to be low in sections where the distance to the movement start point 61 is not so short, it is possible to reduce the power consumption involved in the position estimation processing.

### Second Example of Controlling Estimation Accuracy

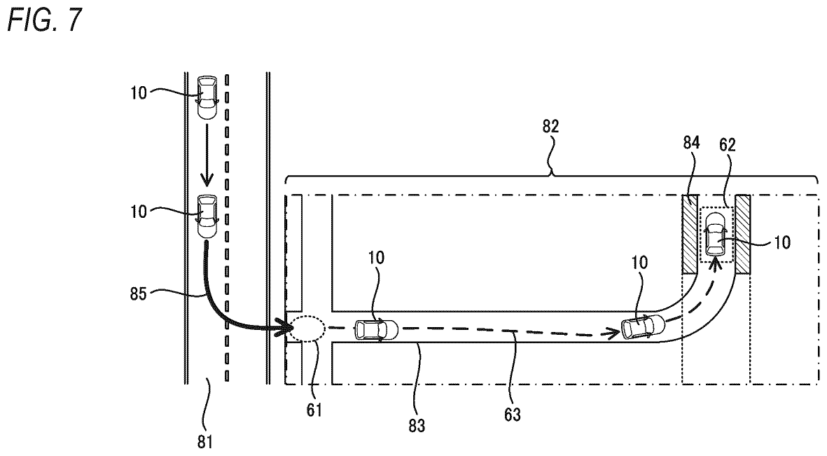

FIG. 7 is a diagram illustrating a second example of controlling the estimation accuracy of the position estimation processing. As illustrated in FIG. 7, when the vehicle 10 enters a driveway 83 in a private property 82 from an ordinary road 81 and performs memory parking to park the vehicle 10 in a garage 84 of the private property 82, control is performed to change the estimation accuracy of the position estimation processing. The driveway 83 is an example of the “non-ordinary road” in the present disclosure.

The user of the vehicle 10 has registered the parking section 62 in the garage 84 in the storage unit 54 as a parking section in which memory parking of the vehicle 10 can be performed. As illustrated in FIG. 7, the parking section 62 is registered in the storage unit 54 as parking information for performing the memory parking, along with the movement start point 61 from which the vehicle 10 begins to move when performing the memory parking, and the movement route 63 (dashed arrow) along which the vehicle 10 travels from the movement start point 61 to the parking section 62.

To register the parking information, the user first manually drives the vehicle 10 to travel, enters the driveway 83 of the private property 82 from the ordinary road 81 as indicated by a solid arrow in FIG. 7, and stops the vehicle 10 at a movement start point (for example, the movement start point 61) which is a position close to a boundary with the ordinary road 81 (where a distance from the boundary is less than a threshold). Next, the user presses, for example, the “start parking information registration” button (not illustrated) for starting the registration of the parking information, and then starts the registration. The user manually drives the vehicle 10 to travel along a route (for example, the movement route 63) along the driveway 83 and parks the vehicle 10 in the garage 84 (for example, the parking section 62). Next, the user presses, for example, the “end parking information registration” button (not illustrated) for ending the registration of the parking information, and then ends the registration. Note that the parking information may also include the features in the external environment information acquired while the vehicle 10 is traveling along the movement route 63.

### Second Example of Position Estimation Processing

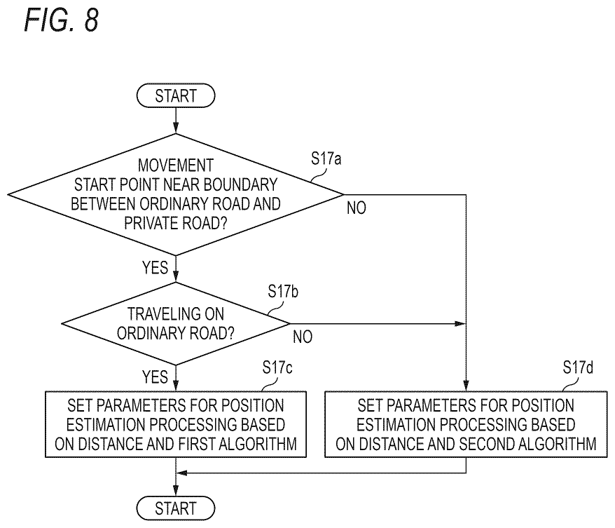

FIG. 8 is a flowchart illustrating a second example of the position estimation processing. The position estimation processing is executed as a first modification of step S17 in the flowchart illustrated in FIG. 5. The present position estimation processing is executed as position estimation processing when the vehicle 10 enters the private property 82 from the ordinary road 81 illustrated in FIG. 7 and is parked in the garage 84 using the memory parking.

The processing from step S11 to step S16 in FIG. 5 is also executed in the present position estimation processing. After deriving the distance from the vehicle 10 to the movement start point 61 in step S16, the vehicle 10 determines whether the movement start point 61 is set to be near the boundary between the ordinary road 81 and a private road (driveway 83), as illustrated in FIG. 8 (step S17a).

If it is determined in step S17a that the movement start point 61 is set to be near the boundary (step S17a: Yes), the vehicle 10 determines whether the vehicle 10 is currently traveling on the ordinary road 81 (step S17b).

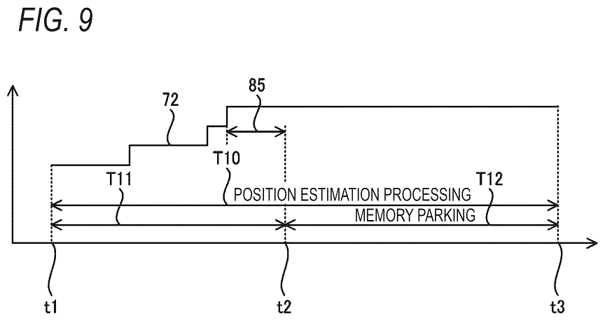

Then, in step S17b, if it is determined that the vehicle 10 is traveling on the ordinary road 81 (step S17b: Yes), the vehicle 10 sets the parameters for the position estimation processing based on the distance to the movement start point 61 derived in step S16 and a first algorithm that changes the estimation accuracy (step S17c). The algorithm here is an algorithm (for example, a function) for calculating parameters based on the distance to the movement start point 61. The first algorithm is an algorithm that provides higher estimation accuracy than a second algorithm described below. That is, when the distance to the movement start point 61 is the same, the first algorithm provides higher estimation accuracy than the second algorithm. However, there may be a distance to the movement start point 61 at which estimation speeds are the same using the first algorithm and the second algorithm. For example, an integrated value of the estimation accuracy using the first algorithm in a section of a certain distance to the movement start point 61 is larger than an integrated value of the estimation accuracy using the second algorithm in the same section. A change in the estimation accuracy according to the first algorithm depending on the distance to the movement start point 61 will be described below with reference to FIG. 9, for example. After setting the parameters, the vehicle 10 returns to step S15 in FIG. 5 and performs the position estimation processing using the parameters set in step S17c.

On the other hand, if it is determined in step S17a that the movement start point 61 is set to be not near the boundary (step S17a: No), or if it is determined in step S17b that the vehicle 10 is not traveling on the ordinary road 81 (step S17b: No), the vehicle 10 sets the parameters for the position estimation processing based on the distance to the movement start point 61 derived in step S16 and the second algorithm that changes the estimation accuracy (step S17d). For example, the change in the estimation accuracy depending on the distance to the movement start point 61 illustrated in FIG. 6 is according to the second algorithm. After setting the parameters, the vehicle 10 returns to step S15 in FIG. 5 and performs the position estimation processing using the parameters set in step S17d.

Although the present example has been described as the first modification of step S17 in the flowchart illustrated in FIG. 5, the present invention is not limited thereto. For example, similar processing may be performed as a first modification of step S13 in the flowchart illustrated in FIG. 5. Although in the above description, the traveling of the vehicle 10 from the ordinary road 81 to the private property 82 and to the movement start point 61 on the driveway 83 is described as traveling under manual driving by the user, but the present invention is not limited thereto. The traveling of the vehicle 10 may be autonomous traveling in which the vehicle 10 is controlled to move to movement start point 61 based on the result of the position estimation processing and the movement start point 61, for example.

### Second Example of Change in Estimation Accuracy

FIG. 9 is a diagram illustrating a second example of the change in the estimation accuracy in the position estimation processing. The change in the estimation accuracy in the present example is applied, for example, when the vehicle 10 enters the private property 82 from the ordinary road 81 illustrated in FIG. 7 and is parked in the garage 84 by the memory parking. In this memory parking, the movement start point 61 is set to be near the boundary between the ordinary road 81 and the driveway 83.

In the second example of FIG. 9, similarly to the first example of FIG. 6, a time t1 on a horizontal axis indicates a timing at which the position estimation processing starts. A time t2 is a timing at which the vehicle 10 arrives at the movement start point 61 of the parking facility 60, and indicates a timing at which the memory parking begins. A time t3 indicates a timing at which the memory parking of the vehicle 10 is completed. A vertical axis indicates a level of the estimation accuracy.

A period T10 from the time t1 to the time t3 is a period during which the position estimation processing for the vehicle 10 is performed. A period T11 from the time t1 to the time t2 is a period of manual driving by the user from when the vehicle 10 enters the private property 82 from the ordinary road 81 until the vehicle 10 arrives at the movement start point 61 on the driveway 83. A period T12 from the time t2 to the time t3 is a period during which the vehicle 10 is caused to travel by the memory parking from the movement start point 61 to the parking section 62 based on the result of the position estimation processing and the parking information.

However, in the present example, a predetermined period before the time t2 in the period T11 is set as a “section 85 immediately before the movement start point”. The “section 85 immediately before the movement start point” is, for example, a section indicated by the thick solid arrow before arriving at the movement start point 61 when the vehicle 10 traveling on the ordinary road 81 turns left and enters the private property 82 in a traveling section of the vehicle 10 illustrated in FIG. 7.

The time t1 at which the position estimation processing starts is a timing at which it is detected that the distance between the vehicle 10 traveling on the ordinary road 81 and the movement start point 61 on the driveway 83 becomes, for example, 100 m or less. When the distance to the movement start point 61 becomes 100 m or less, the vehicle 10 starts the position estimation processing, and estimation accuracy 72 of the position estimation processing is gradually increased according to the distance between the vehicle 10 and the movement start point 61. In the present example, after the start of the position estimation processing (time t1), the vehicle 10 increases the estimation accuracy by four levels as the distance to the movement start point 61 becomes shorter. Since the movement start point 61 is set to be near the boundary between the ordinary road 81 and the driveway 83, the vehicle 10 controls the estimation accuracy when traveling in the section 85 immediately before the movement start point 61 (for example, a section 10 m before) to be higher than the estimation accuracy when traveling before the section 85 immediately before the movement start point 61. In the present example, when the vehicle 10 arrives at the section 85 immediately before the movement start point 61, the estimation accuracy is increased to the highest level. The vehicle 10 performs control so that the increase in the estimation accuracy 72 in the period before the section 85 immediately before the movement start point 61 is steep. Note that the estimation accuracy after arrival at the movement start point 61 (time t2) may be appropriately decreased. For example, the estimation accuracy may be set to the highest level in the section 85 immediately before arriving at the movement start point 61, and the level of the estimation accuracy may be lowered after arriving at the movement start point 61.

In this way, in a case where the movement start point 61 is set to be near the boundary between the ordinary road 81 and the driveway 83 in the private property 82, and the vehicle 10 is about to enter the driveway 83 from the ordinary road 81, the control device increases the estimation accuracy of the position estimation processing in the section 85 immediately before the movement start point 61. With this configuration, it is possible to accurately estimate the position of the vehicle 10 near the movement start point 61. Therefore, the vehicle 10 can smoothly start traveling along the movement route 63 from the movement start point 61 set near the boundary to the parking section 62 in the garage 84. Since the estimation accuracy of the position estimation processing can be controlled to be low when the vehicle 10 is traveling before the section 85 immediately before the movement start point 61, it is possible to reduce the power consumption involved in the position estimation processing.

As described above, the control device increases the estimation accuracy of the position estimation processing in the section 85 immediately before the movement start point 61, and when the vehicle 10 enters the driveway 83, the control device makes the estimation accuracy lower than estimation accuracy in the section 85 immediately before the movement start point 61, depending on, for example, the peripheral environment and the traveling state. In this way, the vehicle 10 can smoothly start traveling along the movement route 63 from the movement start point 61 to the parking section 62, and it is also possible to further reduce the power consumption involved in the position estimation processing.

### Third Example of Position Estimation Processing

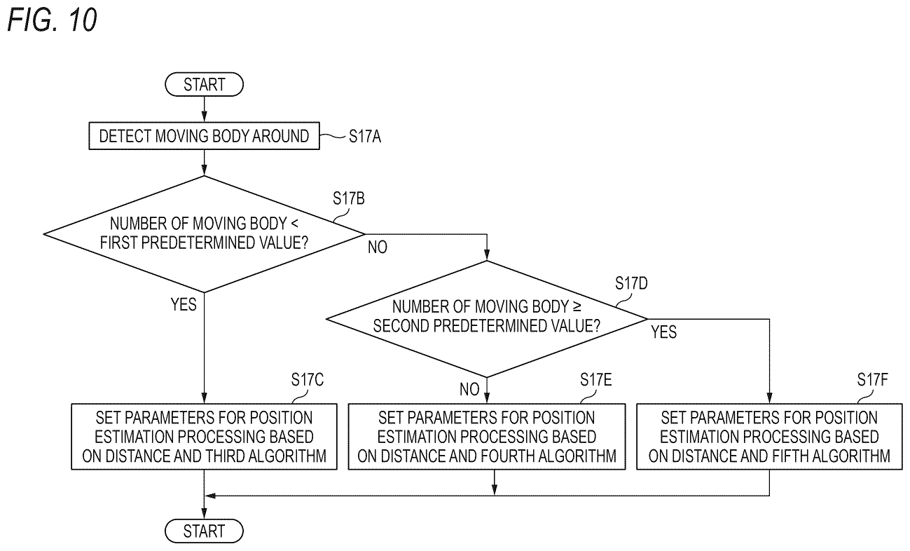

FIG. 10 is a flowchart illustrating a third example of the position estimation processing. The position estimation processing is executed as a second modification of step S17 in the flowchart illustrated in FIG. 5. The present position estimation processing is executed as position estimation processing when the vehicle 10 enters the private property 82 from the ordinary road 81 illustrated in FIG. 7 and is parked in the garage 84 using the memory parking.

The processing from step S11 to step S16 in FIG. 5 is also executed in the present position estimation processing. After deriving the distance from the vehicle 10 to the movement start point 61 in step S16, the vehicle 10 detects the moving body around the vehicle 10 as illustrated in FIG. 10 (step S17A).

The vehicle 10 determines whether the number of the moving body present around the vehicle 10 detected in step S17A is less than a first predetermined value (step S17B).

In step S17B, if the number of the moving body is less than the first predetermined value (step S17b: Yes), the vehicle 10 sets the parameters for the position estimation processing based on the distance to the movement start point 61 derived in step S16 and a third algorithm (step S17C). The third algorithm is an algorithm that provides lower estimation accuracy than a fourth algorithm described below. That is, when there are few moving bodies around the vehicle 10, the position estimation processing is performed with relatively low estimation accuracy.

In step S17B, if the number of the moving body is equal to or greater than a first predetermined value (step S17b: No), the vehicle 10 determines whether the number of the moving body present around the vehicle 10 is equal to or greater than a second predetermined value (step S17D). Here, the second predetermined value is greater than the first predetermined value.

In step S17D, if the number of the moving body is less than the second predetermined value (step S17b: No), the vehicle 10 sets the parameters for the position estimation processing based on the distance to the movement start point 61 derived in step S16 and the estimation accuracy provided by the fourth algorithm (step S17E). The fourth algorithm is an algorithm that provides higher estimation accuracy than the third algorithm. For example, an integrated value of the estimation accuracy using the fourth algorithm in a section of a certain distance to the movement start point 61 is larger than an integrated value of the estimation accuracy using a fifth algorithm in the same section. That is, when there are many moving bodies around the vehicle 10, the position estimation processing is performed with relatively high estimation accuracy.

In step S17D, if the number of the moving body is equal to or greater than the second predetermined value (step S17D: Yes), the vehicle 10 sets the parameters for the position estimation processing based on the distance to the movement start point 61 derived in step S16 and the estimation accuracy provided by the fifth algorithm (step S17F). The fifth algorithm is an algorithm that provides lower estimation accuracy than the fourth algorithm. The fifth algorithm may provide the same estimation accuracy as the third algorithm, or may provide estimation accuracy (lowest estimation accuracy) lower than the third algorithm, for example. That is, when there are too many moving bodies around the vehicle 10, the vehicle 10 performs the position estimation processing with relatively low estimation accuracy. Alternatively, the vehicle 10 may stop the position estimation processing until the number of the moving body becomes less than the second predetermined value, and may not perform memory parking during that period.

The level of the estimation accuracy provided by each algorithm depends on the distance to the movement start point 61, but for example, the level of estimation accuracy may be high or low in comparison at the same distance. However, it is not necessary to differentiate between high and low estimation accuracy for all distances to the movement start point 61. The estimation accuracy is controlled in the same manner as in the processing described with reference to FIG. 8.

Although the present example has been described as the second modification of step S17 in the flowchart illustrated in FIG. 5, the present invention is not limited thereto. For example, similar processing may be performed as a second modification of step S13 in the flowchart illustrated in FIG. 5.

In this way, the control device decreases the estimation accuracy of the position estimation processing when the number of the moving body detected around the vehicle 10 is small (less than the first predetermined number), and increases the estimation accuracy of the position estimation processing when the number of the moving body is relatively large (equal to or greater than the first predetermined number). With this configuration, the position of the vehicle 10 near the movement start point 61 can be accurately estimated, and the vehicle 10 can start traveling smoothly from the movement start point 61, which is set to be near the boundary between the ordinary road 81 and the driveway 83, along the movement route 63 while paying attention to the moving body.

Note that the control method described in the above embodiment may be implemented by executing a control program prepared in advance by a computer. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

The embodiment of the present disclosure has been described above, but the present invention is not limited to the embodiment described above, and modifications, improvements, and the like can be made as appropriate.

In the above embodiment, the vehicle is a four-wheeled automobile, but the vehicle is not limited thereto. For example, the vehicle may be a two-wheeled vehicle, a Segway, or the like. Further, the idea of the present invention is not limited to the vehicle, and may also be applied to a robot, a ship, an aircraft, or the like that includes a drive source and is movable by power of the drive source.

In the present specification, at least the following matters are described. Although corresponding constituent elements or the like in the embodiment described above are shown in parentheses, the present invention is not limited thereto.

(1) A control device (control ECU 20) for a moving object (vehicle 10), the control device including:
a storage unit (storage unit 54) that stores parking information indicating a movement start point (movement start point 61) of the moving object, a parking section (parking section 62) for the moving object, and a movement route (movement route 63) of the moving object from the movement start point to the parking section;
a position estimation unit (position estimation unit 55) that performs position estimation processing with estimation accuracy, the position estimation processing including acquiring external environment information of the moving object, extracting a feature from the external environment information, and estimating a position of the moving object based on the feature and map information; and
a movement control unit (movement control unit 56) that performs movement control to move the moving object from the movement start point to the parking section based on a result of the position estimation processing and the parking information, in which
the position estimation unit sets the estimation accuracy based on a distance between the movement start point and the moving object.

According to (1), by controlling the estimation accuracy of the position estimation processing based on the distance between the movement start point and the moving object, it is possible to reduce the power consumption involved in the position estimation processing while preventing the decrease in convenience caused by inability to accurately estimate the position of the movement start point.

(2) The control device according to (1), in which
the position estimation unit sets the estimation accuracy such that as the distance becomes shorter, the estimation accuracy is higher.

As in (2), by increasing the estimation accuracy of the position estimation processing as the distance between the movement start point and the moving object becomes shorter, the position of the movement start point can be accurately estimated, and the movement control of the moving object starting from the movement start point can be smoothly performed.

(3) The control device according to (1), in which
in a case where a predetermined condition related to the movement start point is satisfied, the position estimation unit increases, as compared with a case where the predetermined condition is not satisfied, the estimation accuracy during a period when the moving object is traveling in a section immediately before the movement start point.

According to (3), when the estimation accuracy of the position estimation processing during the period when traveling in the section immediately before the movement start point is increased, the power consumption involved in the position estimation processing can be reduced by setting a predetermined condition.

(4) The control device according to (3), in which
the predetermined condition is satisfied in response to that the movement start point being set to be near a boundary between an ordinary road and a non-ordinary road.

As in (4), the predetermined condition for increasing the estimation accuracy is preferably that the movement start point is set to be near the boundary between the ordinary road and the non-ordinary road.

(5) The control device according to (4), in which
the predetermined condition is satisfied in response to the movement start point being set to be near the boundary and the moving object being traveling on the ordinary road.

As in (5), the predetermined condition for increasing the estimation accuracy is more preferably a situation in which the moving object is traveling on an ordinary road and is about to enter a non-ordinary road.

(6) The control device according to (5), in which
in response to the predetermined condition being satisfied, the position estimation unit sets the estimation accuracy in the section immediately before the movement start point to predetermined accuracy, and makes the estimation accuracy variable in response to the moving object entering the non-ordinary road.

As in (6), by setting the estimation accuracy in the section immediately before the movement start point to predetermined accuracy and making the estimation accuracy variable after entering the non-ordinary road, it is possible to further reduce the power consumption involved in the position estimation processing.

(7) The control device according to any one of (1) to (6), further including:
a moving body detection unit that detects a moving body around the moving object based on the external environment information, in which
the position estimation unit sets the estimation accuracy based on the number of the detected moving body.

According to (7), the estimation accuracy of the position estimation processing can be controlled based on the number of the moving body detected around the moving object, thereby reducing the power consumption involved in the position estimation processing.

(8) The control device according to (7), in which
the position estimation unit increases, as compared with a case where the number of the moving body is less than a first predetermined number, the estimation accuracy in a case where the number of the moving body is equal to or greater than the first predetermined number.

As in (8), when a large number of moving bodies are detected around the moving object, it is preferable to increase the estimation accuracy of the position estimation processing as compared with the case where the number of the moving body is small.

(9) The control device according to (8), in which
the position estimation unit decreases, as compared with a case where the number of the moving body is equal to or greater than the first predetermined number and less than a second predetermined number, the estimation accuracy in a case where the number of the moving body is equal to or greater than the second predetermined number, the second predetermined number being greater than the first predetermined number.

As in (9), when there are too many moving bodies detected around the moving object, it is preferable not to increase the estimation accuracy of the position estimation processing.

(10) A control method of a control device for a moving object, the control method including:
storing parking information indicating a movement start point of the moving object, a parking section for the moving object, and a movement route of the moving object from the movement start point to the parking section;
performing position estimation processing with estimation accuracy, the position estimation processing including acquiring external environment information of the moving object, extracting a feature from the external environment information, and estimating a position of the moving object based on the feature and map information;
performing movement control to move the moving object from the movement start point to the parking section based on a result of the position estimation processing and the parking information; and
setting the estimation accuracy based on a distance between the movement start point and the moving object.

According to (10), by controlling the estimation accuracy of the position estimation processing based on the distance between the movement start point and the moving object, it is possible to reduce the power consumption involved in the position estimation processing while preventing the decrease in convenience caused by inability to accurately estimate the position of the movement start point.

(11) A non-transitory computer-readable storage medium storing a control program that causes a processor of a control device for a moving object to execute a process, the process includingstoring parking information indicating a movement start point of the moving object, a parking section for the moving object, and a movement route of the moving object from the movement start point to the parking section,
performing position estimation processing with estimation accuracy, the position estimation processing including acquiring external environment information of the moving object, extracting a feature from the external environment information, and estimating a position of the moving object based on the feature and map information,
performing movement control to move the moving object from the movement start point to the parking section based on a result of the position estimation processing and the parking information, and
setting the estimation accuracy based on a distance between the movement start point and the moving object.

According to (11), by controlling the estimation accuracy of the position estimation processing based on the distance between the movement start point and the moving object, it is possible to reduce the power consumption involved in the position estimation processing while preventing the decrease in convenience caused by inability to accurately estimate the position of the movement start point.

What is claimed is:

1. A control device for a moving object, the control device comprising:
a storage that stores parking information indicating a movement start point of the moving object, a parking section for the moving object, and a movement route of the moving object from the movement start point to the parking section; and
processing circuitry configured to
perform position estimation processing with estimation accuracy, the position estimation processing including acquiring external environment information of the moving object, extracting a feature from the external environment information, and estimating a position of the moving object based on the feature and map information, and
perform movement control to move the moving object from the movement start point to the parking section based on a result of the position estimation processing and the parking information, wherein
the processing circuitry is configured to set the estimation accuracy based on a distance between the movement start point and the moving object.

2. The control device according to claim 1, wherein
the processing circuitry is configured to set the estimation accuracy such that as the distance becomes shorter, the estimation accuracy is higher.

3. The control device according to claim 1, wherein
in a case where a predetermined condition related to the movement start point is satisfied, the processing circuitry increases, as compared with a case where the predetermined condition is not satisfied, the estimation accuracy during a period when the moving object is traveling in a section immediately before the movement start point.

4. The control device according to claim 3, wherein
the predetermined condition is satisfied in response to that the movement start point being set to be near a boundary between an ordinary road and a non-ordinary road.

5. The control device according to claim 4, wherein
the predetermined condition is satisfied in response to the movement start point being set to be near the boundary and the moving object being traveling on the ordinary road.

6. The control device according to claim 5, wherein
in response to the predetermined condition being satisfied, the processing circuitry sets the estimation accuracy in the section immediately before the movement start point to predetermined accuracy, and makes the estimation accuracy variable in response to the moving object entering the non-ordinary road.

7. The control device according to claim 1, wherein
the processing circuitry is further configured to
detect a moving body around the moving object based on the external environment information, and
set the estimation accuracy based on the number of the detected moving body.

8. The control device according to claim 7, wherein
the processing circuitry is configured to increase, as compared with a case where the number of the moving body is less than a first predetermined number, the estimation accuracy in a case where the number of the moving body is equal to or greater than the first predetermined number.

9. The control device according to claim 8, wherein
the processing circuitry is configured to decrease, as compared with a case where the number of the moving body is equal to or greater than the first predetermined number and less than a second predetermined number, the estimation accuracy in a case where the number of the moving body is equal to or greater than the second predetermined number, the second predetermined number being greater than the first predetermined number.

10. A control method of a control device for a moving object, the control method comprising:
storing parking information indicating a movement start point of the moving object, a parking section for the moving object, and a movement route of the moving object from the movement start point to the parking section;
performing position estimation processing with estimation accuracy, the position estimation processing including acquiring external environment information of the moving object, extracting a feature from the external environment information, and estimating a position of the moving object based on the feature and map information;
performing movement control to move the moving object from the movement start point to the parking section based on a result of the position estimation processing and the parking information; and
setting the estimation accuracy based on a distance between the movement start point and the moving object.

11. A non-transitory computer-readable storage medium storing a control program that causes a processor of a control device for a moving object to execute a process, the process comprising
storing parking information indicating a movement start point of the moving object, a parking section for the moving object, and a movement route of the moving object from the movement start point to the parking section,
performing position estimation processing with estimation accuracy, the position estimation processing including acquiring external environment information of the moving object, extracting a feature from the external environment information, and estimating a position of the moving object based on the feature and map information,
performing movement control to move the moving object from the movement start point to the parking section based on a result of the position estimation processing and the parking information, and
setting the estimation accuracy based on a distance between the movement start point and the moving object.
